(19) United States
(12) Patent Application Publication
(10) Pub. No.: US 2012/0249419 A1
(43) Pub. Date: Oct. 4, 2012

(54) THUMB MOUNTABLE CURSOR CONTROL AND INPUT DEVICE

(76) Inventors: Dennis M. Bronner, SR., Birch Run, MI (US); Craig L. Stephenson, Flushing, MI (US)

(21) Appl. No.: 13/075,840

(22) Filed: Mar. 30, 2011

(51) Int. Cl. G06F 3/033

(52) U.S. Cl. 345/157

(57) ABSTRACT

A hand wearable, cursor control and input system for a computer or other electronic device. The cursor control and input system includes a thumb mouse device having a sheath or sleeve for receiving one finger of a person's hand therein. Located on the sheath is a touchpad sensor that is oriented to be contact by a finger on the same hand of the user and that is configured to translate motion and position of a user's finger drawn across the touchpad sensor to a relative position of a cursor or pointer on a display screen of the computer or other electronic device. The surface of the touchpad sensor is delineated into two separate tap regions that respectively and correspondingly function as left and right buttons of a conventional computer mouse.

### BACKGROUND

1. Field of the Invention

The present invention generally relates to the field of peripheral input devices used in connection with other electronic devices, those other devices including devices such as general and personal computers. More specifically, the invention relates to an alternative device that controls positional movement of a cursor on a video display and the various “click” controls that implement the “select” function, the “drag” function, and various other functions associated with mouse-type devices.

2. Description of Related Art

Computers and other electronic devices (hereafter just “computer”) are widely used throughout the world on an everyday basis. These devices have found themselves being used, not only in the business world and government environments, but also in schools, homes, and more recently in public places such as coffee shops, airports and public parks. Conventionally, computers employ a display screen and are operated using a keyboard and a mouse. The keyboard is used to enter text and commands. The mouse is typically used to control the location and movement of a cursor on the display screen and is used for inputting various commands into the computer. The mouse typically includes a tracking device for measuring the movement of the mouse across the surface supporting the mouse. This movement is relayed to the computer where it is translated into a corresponding movement of the cursor on the display screen. These tracking devices are often roller ball or optical devices, such as a laser, and are well known and widely implemented. The mouse is connected to the computer by way of a cable and a connector, such as a USB connector. Alternatively, the mouse communicates wirelessly to the computer via infrared or radio frequencies. In addition to the tracking device, the mouse typically includes one or more buttons. These buttons operate as switches to initiate a function or command identified at the location of the cursor. By clicking the button, the command is initiated. Alternatively, the buttons can be configured to operate various features of the software running on the computer or electronic device. There are many possible such features and representative ones include the highlighting of text in a word processing program or the displaying of a menu of commands and the selecting of a command therefrom.

A conventional mouse of the above described variety has several drawbacks. One particular drawback arises in connection with use of the mouse with a keyboard. When used in conjunction with a keyboard, in order to control movement of the cursor on the display screen and to select various software commands displayed on the screen, the user must remove their hand from the keyboard and then reach for and grasp the mouse. Thus, the person using the keyboard and mouse must frequently move their hand between the keyboard and the mouse. Depending on the activity, this movement between the keyboard and the mouse can be very frequent. Obviously, as the frequency of the movement increases, the movement can become both cumbersome and time consuming.

In view of the above, it is apparent that there exists a need for a more efficient cursor control and input device, one that would improve the productivity and performance of the person using the device and eliminate the need to move one's hand back and forth from the keyboard to the mouse.

### SUMMARY

In overcoming the above and other drawbacks of the known technology, the present invention provides a peripheral input device that is intended to be worn on a user's hand, specifically on one finger of the user's hand, and even more specifically on a user's thumb. The glove includes fittings for various fingers and sensor/contacts are provided in the fittings. By manipulation of the user's fingers, bringing various fittings into engagement with one another, and therefore various sensors and contacts into close proximity with one another, the user is able to perform the various operations tasks associated with a computer mouse.

Accordingly, in one aspect, the present invention is a wearable cursor control and input device for a computer. The cursor control and input device includes a single finger fitting that is configured to receive therein one finger, such as the thumb, of the user's hand. Located on the finger fitting is a touchpad sensor. The touchpad sensor is oriented so that it may be contacted by a finger on the same hand of the user and is coupled to a controller. The controller is configured to translate the motion and position of a user's finger being drawn across the surface of the touchpad sensor into relative and corresponding positioning of a cursor or pointer on the display screen of the computer. Additionally, the touchpad sensor is divided into at least two tap regions. One of the regions operates as a right button when sensing the tap of a finger thereon. The other region operates as a left button when sensing the tap of a finger thereon. The regions may together be coextensive with the surface of the touchpad sensor or the regions may be defined a subsection of the overall surface of the touchpad sensor.

In another aspect of the invention, the cursor control and input device further includes a communication means for enabling communication of the cursor control and input device with the computer. In a preferred embodiment, the communication mean is a wireless connection including a transmitter, such as a radio frequency transmitter or an infrared transmitter. However, the communication means may be a wired connection to the computer.

In further aspect of the invention, the touchpad is a capacitance touchpad or a conductance touchpad sensor.

In still another aspect of the invention, the touchpad is flexible.

In still another aspect of the invention, the finger fitting is formed of a resilient material.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a peripheral input device, embodying the principles of the present invention, as seen on the thumb of a user, when viewed looking downward on the user's hand from the perspective of the user;

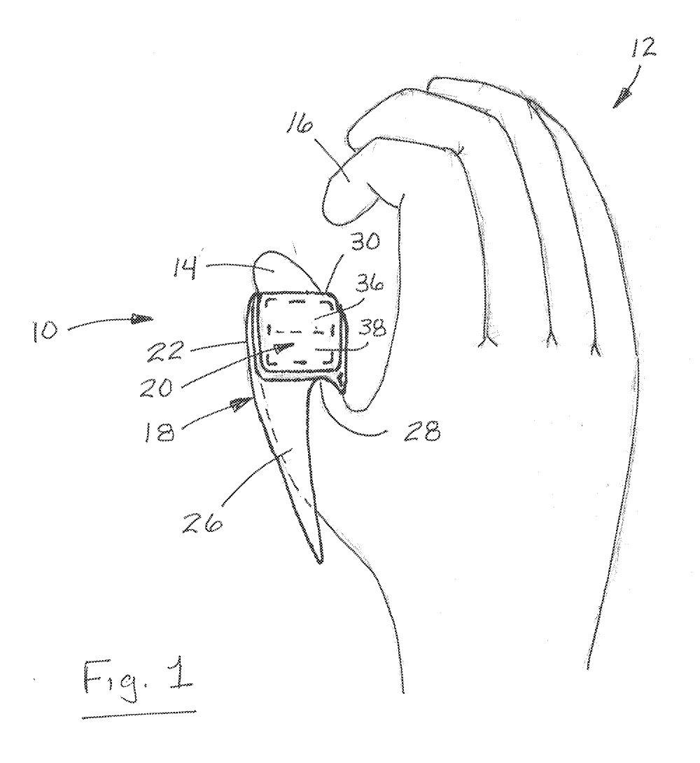

FIG. 2 illustrates the peripheral input device of FIG. 1, as viewed from one side of the user's hand;

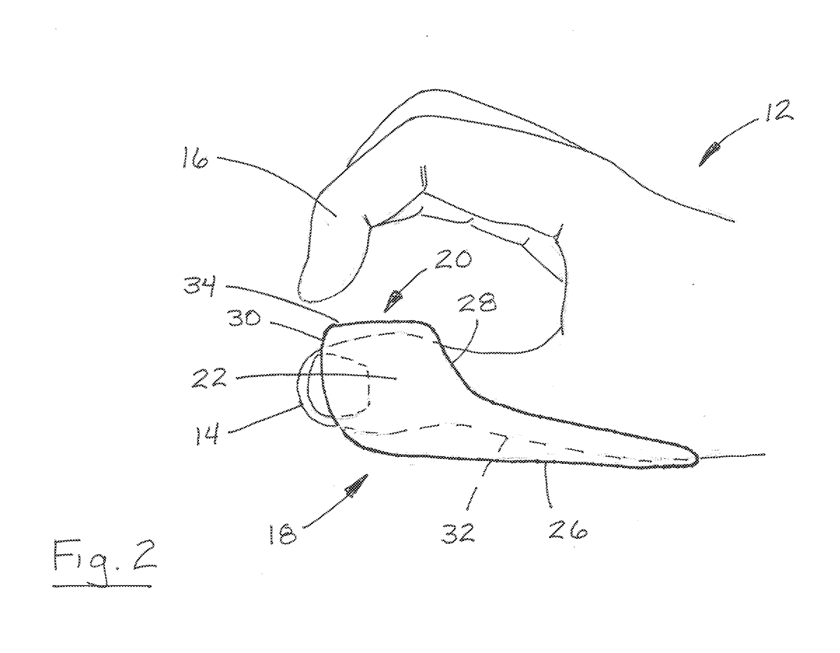

FIG. 3 is an end view of the peripheral input device of FIGS. 1 and 2; and

FIG. 4 is block diagram of a computer system incorporating a peripheral input device in accordance with the principles of the present inventions.

### DETAILED DESCRIPTION

Referring now to the drawings, a peripheral input device embodying the principles of the present invention is illustrated therein and generally designated at 10. As seen therein, the peripheral input device 10 is worn on a user's hand 12, more particularly on one finger of the user's hand and, most preferably, on the thumb 14 of the user's hand 12. For this reason, the peripheral input device is herein being referred to as a “thumb mouse,” it being acknowledged that this terminology is not known to be a term of art in the industry.

While the thumb mouse 10 is shown as being worn on the thumb 14 of the user's hand 12, it will be appreciated that the principles embodied by the thumb mouse 10 are readily adaptable for implementation on the index finger 16 or another finger of a user's hand 12. In the discussion that follows, however, the thumb mouse 10 will be shown and described with reference to it being worn on a user's thumb 14. It will be understood that the description similarly applies to embodiments and situations where the thumb mouse 10 is worn on the index finger 16 or another fingers of a user's hand 12.

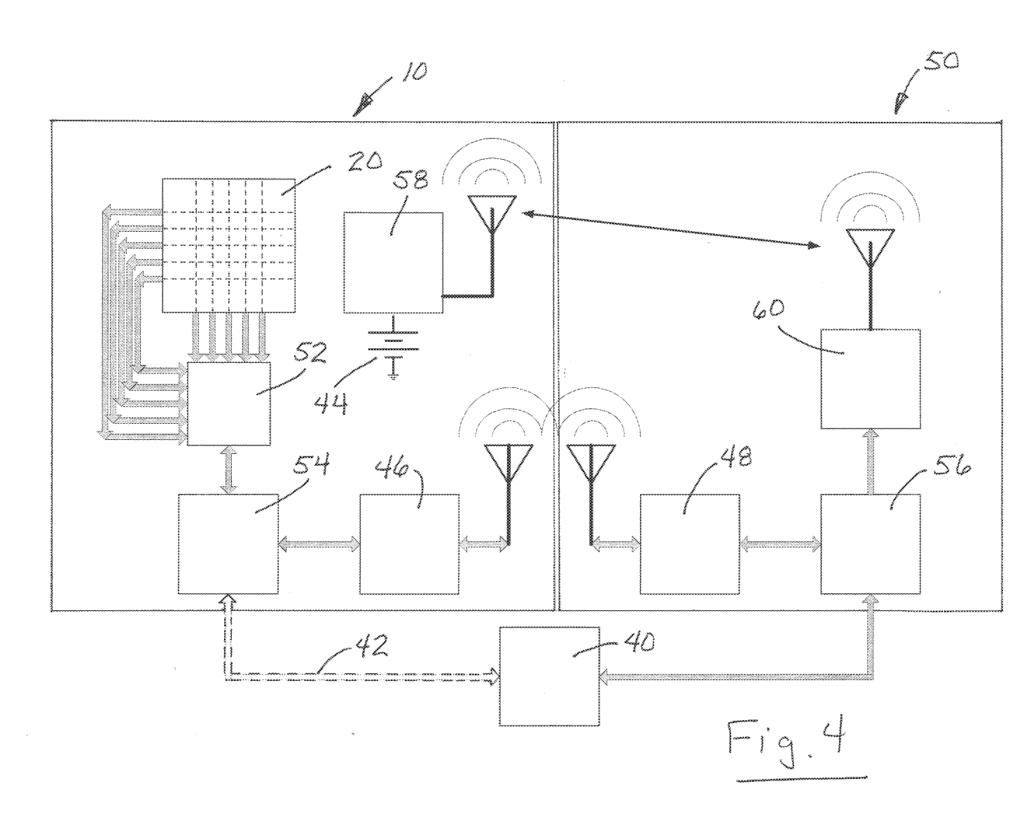

The thumb mouse 10 has as its primary components a sheath or sleeve 18 on which is supported a touchpad sensor 20. A further, separate component of the thumb mouse 10 is a PC interface module 50. The interface module 50, which is more fully discussed below in connection with FIG. 4.

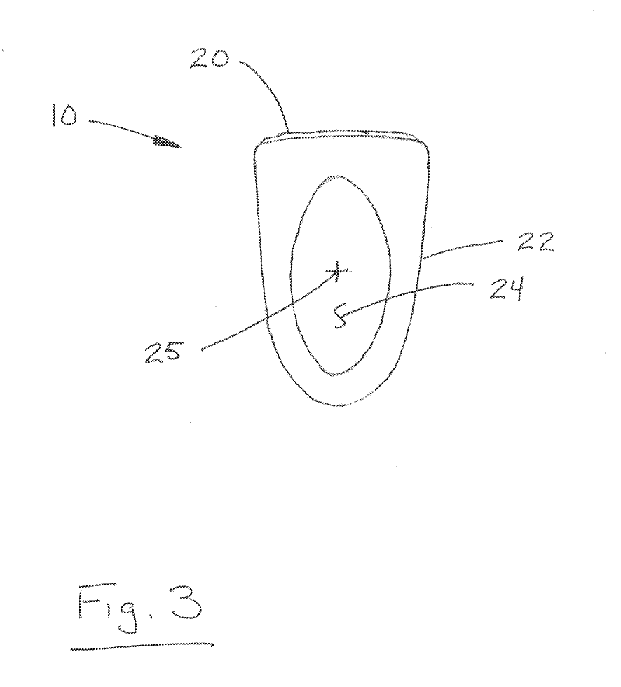

The sheath 18, in its most basic form, has a sleeve portion 22 through which is defined a passageway 24. The passageway 24, which is best seen in FIG. 3, preferably extends all the way through the sheath and generally defines a central axis 25 along which a user is to insert their thumb so as to secure the thumb mouse 10 on their thumb 14. While illustrated as extending all the way through the sheath 18, the passageway 24 may extend less than all the way through the sleeve portion 22. In the latter embodiment, the sheath 18 would include an end wall covering the distal end of the user's thumb 14.

In the illustrated embodiment, the sheath 18 further includes a brace 26 formed as an axial extension off of the rear side 28 of the sleeve portion 22. As used herein, the rear side 28 of the sleeve portion 22 is the side of the sleeve portion 22 that first receives the user's thumb 14, when the thumb 14 is being inserted into the passageway 24 of the thumb mouse 10. Conversely, the front side 30 of the thumb mouse 10 is that side closest to the tip of the user's thumb, when the thumb mouse 10 is worn on a user's thumb 14. (Directional nomenclature used herein is intended to be interpreted with reference to the user's hand when viewed from the perspective of the user.) The brace 26 extends from the rear side 18 of the sleeve portion 22 in the form of a tapered flange or extension and generally lies along the lateral side 32 of the user's thumb 14 when worn thereon. Positioned in this manner, the brace 26 operates to limit movement of the thumb mouse 10 on the user's thumb 14, whether such movement is rotational or transverse to the thumb 14.

The sheath 12 may be made out of a variety of materials including various textiles or fabrics, leather, or plastic. Preferably, the sheath 12 is formed of a durable material having a slight elasticity so as to enable the sheath 12 to expand slightly when donned and so as to conform to the shape of the user's thumb 14 when the thumb 14 is inserted therein and so as to assist in retaining the thumb mouse 10 thereon. Alternatively, the material forming the sheath 12 may be rigid or exteriorly rigid and lined with a non-rigid and/or more compliant or conforming material.

Positioned on the inner lateral side 34 of the sleeve portion 22, which is the side of the thumb mouse 10 located generally toward the index finger 16, is the touchpad sensor 20. Preferably, the touchpad sensor 20 is of the well-known capacitance sensing variety and is sufficiently flexible so as not to be susceptible to breakage during normal use of the thumb mouse 10. Alternatively the touchpad sensor 20 may be of a conductance variety or other variety.

The thumb mouse 10 is intended to provide all of the functional attributes of a conventional computer mouse. In this regard, the touchpad sensor 20 is oriented so that it may be contact by the index finger 16 of the user's same hand. When the tip of the user's index finger 16 is brought into contact with the touchpad sensor 20 and moved across its surface, this movement is translated into movement of a cursor on the display of the computer. Thus, by moving the index finger 16 upward along the touchpad sensor 20, generally toward the tip of the thumb 14, the cursor is caused to move upward on the display of the computer. Conversely, movement of the index finger 16 in an opposite direction, downward along the touchpad sensor 20, would cause downward movement of the cursor on the display of the computer. Movement to the right or left on the touchpad sensor 20 during engagement of the index finger 16 will cause corresponding right and left movement of the cursor. While not fully discussed herein, one skilled in touchpad technology will readily appreciate how to effectuate the workings of a touchpad sensor to control movement of a cursor on a computer screen since touchpads are standard items on laptop computers.

The touchpad sensor 20 is further divided into two tap regions. For reasons that will become apparent, these regions are referred to as the right and left tap regions and are designated as 36 and 38, respectively. The right and left tap regions 36 and 38 may together be coextensive with the surface of the touchpad sensor 20. Alternatively, the right and left tap regions 36 and 38 may be delimited, less than the full extend, within the surface of the touchpad sensor 20.

When the index finger 16 is brought into engagement with the touchpad sensor 20, the engagement is registered as a signal different depending on the nature of the contact and the location of the contact. If the engagement is one where the index finger 16 resides on the touchpad sensor 20 for a given period of time and transverses the surface of the touchpad sensor 20, the resulting signal is interpreted as a “cursor movement” signal and the cursor moved in accordance with the motion of the index finger 16 across the surface of the touchpad sensor 20. If the engagement is brief and one where the index finger 16 only momentarily contacts or taps the surface of the touchpad sensor 20, then this engagement is interpreted as a “click” signal. Depending on whether this signal occurs in the right or left tap region 36, 38, the signal is correspondingly interpreted as either a right or left click signal and respectively and functionally corresponds to either a right or left button click of a conventional computer mouse. If the index finger 16 is brought into engagement with the touchpad sensor 20 twice in succession, this engagement is registered as a double tap of either the right or left tap regions 36, 38 and interpreted as right or left double button clicks on a computer mouse.

The various engagement signals are communicated to and processed by the computer, which interprets them as moving the position of the cursor, selecting of the object then associated with the position of the cursor on the display or another command, such as displaying a drop down menu of the computer.

Preferably, the thumb mouse 10 is provided in a wireless form such that the thumb mouse 10 is not physically connected to the computer with which it is being used. If provided in a non-wireless form, however, the thumb mouse 10 is connected to a computer 40 by way of a cable 42 having a USB connector, or other computer connector, provided on the end thereof. This wired form is alternatively illustrated in FIG. 4.

As principally illustrated in FIG. 4, the thumb mouse 10 is preferably provided in a wireless form. Being wireless, the thumb mouse 10 includes an on/off switch that is connected to a power source, such as a battery 44. When turned on, the various components of the thumb mouse 10 are able to provide signals that are relayed via a wireless communications transceiver 46 on the thumb mouse 10 to a corresponding wireless communications transceiver 48 of a PC interface module 50, which is itself connected to (via USB or other connection), or integrated with, the computer 40. The thumb mouse 10 and interface module 50 may communicate by anyone of various known communication techniques, including infrared communication and short range radio frequency communications, such as Bluetooth™ technology, the latter of which are preferred.

In operation, a user wearing the thumb mouse 10 contacts the touchpad sensor 20 with their index finger 16. The touchpad sensor 20 registers this contact and provides corresponding signals to a touchpad controller 52. The touchpad controller 52 correlates the contact signals into signals indicating the location of the contact on the touchpad sensor 20. The touchpad controller 52 then provides these location signals to a touchpad microprocessor 54, which is connected to the wireless communications transceiver 46 of the thumb mouse 10. The touchpad microprocessor 54 causes the location signals to be transmitted by the transceiver 46 to the transceiver 48 of the interface module 50. In the interface module 50, the received signal is received from the transceiver 48 by an interface module microprocessor 56, which in turn communicates with the computer 40, causing the cursor on the display of the computer 40 to move in accordance with the movement of the index finger 16 over the surface of the touchpad sensor 20.

As mentioned previously, the thumb mouse 10 is powered by an on-board battery 44. As seen in FIG. 4, the battery 44 may be a rechargeable battery. In order to recharge the battery 44, the thumb mouse 10 may include a power receiver controller 58 in electrical communication with the battery 44. The receiver controller 58 is a wireless device that communicates with a power transmitter 60, which may be integral with the interface module 50. If integral with the interface module 50, operation of the power transmitter may be controlled by the microprocessor 56. The power transmitter 60 may deliver power to the power received via one of several known techniques, including an inductive coupling or a radio frequency coupling. In that such wireless battery charging systems are generally known, further details regarding the construction and operation thereof is not required herein.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I/We claim:

1. A finger wearable, cursor control and input device for a computer or other electronic device, the cursor control and input device comprising:
a finger sleeve having portions defining a passageway therein for receiving one finger of a person's hand;
a touchpad sensor located on the sleeve and positioned on the sleeve to enable contact of the touchpad sensor with another finger of the person's same hand, the touchpad sensor configured to translate motion and position of a user's finger being drawn across the touchpad sensor to a relative position of a cursor or pointer on a display screen of the computer or other electronic device;
a controller coupled to the touchpad sensor, the controller correlating the motion and position of the user's finger drawn across the touchpad sensor into a position signal;
communication means for communicating the signal to the computer; and
whereby the cursor of the computer is correspondingly moved in response to the signal.

2. The cursor control and input device of claim 1 wherein the communication means is a wired connection to the computer and includes a cable connecting the device to the computer.

3. The cursor control and input device of claim 1 wherein the communication means is a wireless communication system.

4. The cursor control and input device of claim 1 wherein the communication means includes a mouse transceiver supported by the sleeve and in communication with the touchpad sensor, the mouse transceiver configured to communicate the signals regarding motion and position of the user's finger drawn across the touchpad sensor.

5. The cursor control and input device of claim 4 wherein the communication means includes an interface module, the interface module being physically separate from sleeve and being connectable to the computer.

6. The cursor control and input device of claim 6 wherein the interface module includes an interface transceiver configured to receive from the mouse transceiver the signals regarding motion and position of the user's finger drawn across the touchpad sensor, the interface transceiver further configured to provide the signals to the computer.

7. The cursor control and input device of claim 4 wherein the mouse transceiver is a radio frequency transmitter.

8. The cursor control and input device of claim 4 wherein the mouse transmitter is an infrared transmitter.

9. The cursor control and input device of claim 1 wherein the touchpad sensor is a capacitance touchpad sensor.

10. The cursor control and input device of claim 1 wherein the touchpad sensor is a conductance touchpad sensor.

11. The cursor control and input device of claim 1 wherein the touchpad sensor is flexible.

12. The cursor control and input device of claim 1 wherein the touchpad sensor is delineated into a first tap region and a second tap region, wherein the controller is configured to correlate touch contact in the first tap region to clicking of a left mouse button of a conventional computer mouse and to correlate touch contact in the second tap region to clicking of a right mouse button of a conventional mouse.

13. The cursor control and input device of claim 13 wherein the first and second tap regions are occupy adjacent sides of the touchpad sensor.

14. The cursor control and input device of claim 14 wherein the first and second tap regions occupy the full surface of the touchpad sensor.

15. The cursor control and input device of claim 14 wherein one of the first and second tap region is located on the front side of the touchpad sensor.

16. The cursor control and input device of claim 16 wherein the other of the first and second tap region is located on the rear side of the touchpad sensor.

17. The cursor control and input device of claim 14 wherein the first tap region is located on the lateral side of the touchpad sensor oriented toward the left when the person's hand is viewed from the backside of the hand and from the person's perspective.

18. The cursor control and input device of claim 18 wherein the second tap region is located on the lateral side of the touchpad sensor oriented toward the right when the person's hand is viewed from the backside of the hand and from the person's perspective
